(19) United States
(12) Patent Application Publication
(10) Pub. No.: US 2003/0067450 A1
(43) Pub. Date: Apr. 10, 2003

(54) Interactive system and method of interaction

(76) Inventors: Paul Philip Thursfield, Eindhoven (NL); Othmar Vincent Schimmel, Eindhoven (NL); Lucas Jacobus Franciscus Geurts, Eindhoven (NL)

Correspondence Address: U.S. Philips Corporation, 580 White Plains Road, Tarrytown, NY, 10591, US

(21) Appl. No.: 10/247,978

(22) Filed: Sep. 20, 2002

(30) Foreign Application Priority Data
Sep. 24, 2001 (EP) 01203661.2

(51) Int. Cl. G09G 5/00

(52) U.S. Cl. 345/173

(57) ABSTRACT

An interactive system (130) is described that generates real-time sound feedback for interaction with a screen (100) with a touch and pressure sensitive panel. On the screen a finger or tools like pen shaped objects (112) can be used for drawing in the plane of the screen (100). A number of different tools can be used which have different sound feedback. During the actual drawing with a finger or a tool on the touch screen, a number of audio control parameters are used to control the sound playback in real-time. Each tool (112) has its own typical interaction sound which is designed to fit the physical, virtual and interaction result of this object on the touch screen.

The invention relates to an interactive system comprising: an input device for inputting data to the interactive system, the inputting being effected by a user operation upon the input device.

Furthermore the invention relates to a method of interaction, the method comprising: inputting data to an input device, the inputting being effected by a user operation upon the input device.

An embodiment of the interactive system and method as set forth above is generally known from audio systems wherein the volume of the sound can be controlled. These volume controls are often provided by means of a slider or touch keys. When a slider is used, the position of the slider determines the volume of the sound. In the case that touch keys are provided, pressing the touch key will cause the volume to increase or to decrease. If the audio system provides access to the pitch of the sound, pitch controls are provided. These pitch controls are also often provided by means of a user interface comprising a slider or touch keys that can be operated correspondingly.

An other embodiment of the interactive system and method as set forth above is also generally known from a personal computer that is connected to a speaker system. Then the volume and pitch controls are provided by the software run by the personal computer through a software generated user interface control gadget. This user interface control gadget also provides a slider or a button gadget that can be operated via an input device, like a keyboard, mouse or joystick. The interaction models of the slider and the button with respect to controlling the volume or pitch are the same as the interaction model for the audio system as previously described. Furthermore, when the personal computer is provided with a touch screen, other input devices can be used like a pen or a finger to operate upon the software generated user interface control gadget.

However, for each of the above described embodiments the interaction model with the acoustic signal is generally independent from the pointing device used.

It is an object of the current invention to provide an interactive system that provides a more intuitive interaction model with an acoustic signal depending upon a user operation with the interactive system. To achieve this object, the interactive system according to the preamble is characterized in that the interactive system further comprises:

measuring means conceived to measure a parameter of the user operation; and

converting means conceived to convert the measured parameter into an acoustic signal that depends upon the measured parameter of the user operation.

By measuring a parameter of the user operation, different user operations provide different interaction experiences. The user operation can be performed with, for example a pen, a pencil, a brush, an eraser or even a finger. Each of these, so called pointing “devices” in real-life produces a different sound when they are used. For example, a pen will produce a noise at a different volume level than a pencil, a brush or an eraser. Furthermore, each pointing device can be operated according to its interaction model: an eraser can erase parts of already drawn objects, a pen can create lines that are mostly less blurred than lines created with a pencil or a brush. Furthermore, the acoustic feedback the user experiences does not depend upon the kind of data the user manipulates, but upon the way the user performs his operation upon the input device. This means, for example, that the same drawing can be drawn with both a simulated pen or a crayon with different acoustic feedback depending upon the chosen pointing device and how the pointing device is operated.

A further advantage of the interactive system according to the invention is achieved, by reducing the need for a user to locate, manipulate and be aware of a dedicated user interface to control the audio, the interaction with the system can be used for, for example, drawing while controlling the audio. Furthermore, the user is less aware of the fact that the audio is controlled in real-time via the interaction which makes the experience of the chosen interaction, like drawing with a finger, or pencil more real.

An embodiment of the interactive system according to the invention is described in claim 2. By letting pressure control the acoustic feedback, experience of the user of his operation with the input device becomes further intuitive. For example, applying more pressure to the input device increases the volume level of the media device. This can be compared to pressing a pen on a piece of paper while writing: the more pressure is applied, the louder the noise of the pen touching the paper.

An embodiment of the interactive system according to the invention is described in claim 3. By letting the position control the acoustic feedback an additional dimension of user experience is added. For example when a pen which is moved with more speed makes more noise than a pen that is moved with a lower speed. Furthermore, a pointing device that is moved away from the user in general makes a lower noise at a decreasing volume level than a pointing device that is moved towards a user which in general makes a higher noise at an increasing volume level.

An embodiment of the interactive system according to the invention is described in claim 4. By letting the orientation, like for example the orientation of a crayon with respect to the surface onto which one is drawing, influence acoustic feedback, the realtime experience of the user is improved more. Then, for example, writing with the crayon while holding it perpendicular to the surface can make a different noise than writing with the crayon while holding it in parallel to the surface.

Further embodiments of the interactive system according to the invention are described in claims 5 to 8.

Furthermore, it is an object of the current invention to provide a method of interaction that provides a more intuitive interaction model with audio controls depending upon the pointing device used. To achieve this object, the method of interaction is characterized in that the method further comprises:

measuring a parameter of the user operation; and

converting the measured parameter into an acoustic signal that depends upon the measured parameter of the user operation.

The invention will be described by means of embodiments illustrated by the following drawings

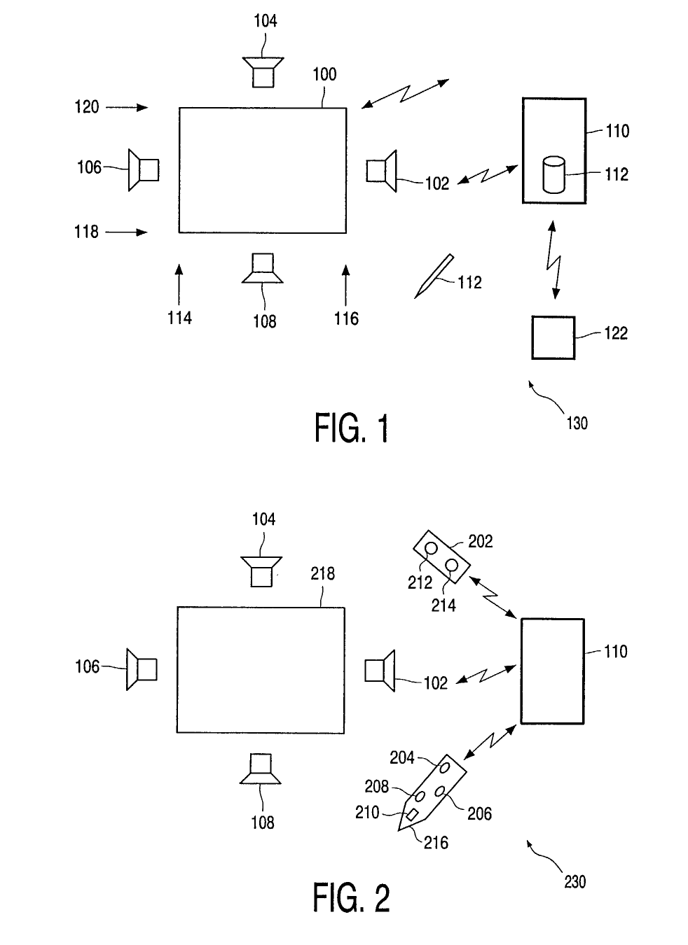

FIG. 1 illustrates an overview of the general parts of the interactive system according to the invention.

FIG. 2 illustrates the general parts of an embodiment of the interactive system with a camera array according to the invention in a schematic way.

Within these Figures, corresponding reference numerals correspond to corresponding parts of the Figures.

FIG. 1 illustrates an overview of the general parts of the interactive system according to the invention in a schematic way. Here 100 is a touch screen, like an LCD touch screen which comprises pressure sensors (not shown). The position and the pressure of an object, like a pen, on the screen are transmitted to a personal computer 110. The personal computer 110 comprises software that can interpret the position and pressure parameters and translates these parameters into audible feedback. The audible feedback is then transmitted to speakers 102, 104, 106, and 108. More speakers can be used too to create a surrounding effect.

With this interactive system 130, especially narrative activities like teaching, presenting and playing are enriched, because it creates the experience of real-time sound feedback, which resembles the interaction of a physical object on a surface. For example, when a user wants to write on a paper with a pen, the screen 100 simulates the paper and a dedicated pointing device 112 shaped as a pen, simulates the pen. Then, when the user starts “writing” on the surface of the screen 100, the location, speed and pressure of this interaction is sent to the personal computer 110. Here, the location parameter is used to position the sound in the plane surrounded by the speakers, such that the user experiences that the sound comes from the location of the pointing device 112. For example, if the interaction moves from left 114 to right 116, the volume of the left speaker 106 decreases. If the interaction moves from the front 118 to the back 120, the volume of the bottom speaker 108 decreases. Other mappings of movement to increase and decrease of speakers are also possible, such that the user experiences that he moves the pointing device towards him or away from him.

The speed parameter is used to control the overall volume of the feedback sound. If the speed is zero, the volume is set to zero. The volume level increases if the speed is increased.

The pressure parameter is used to control the pitch of the sound. If more pressure is applied, the pitch will go up.

It is also possible that both the speed and pressure parameters control the volume of the sound or that other parameters of the sound like its beat are controlled. Furthermore, the parameters can be used to concurrently control the interaction of the pointing device with the screen. For example, when a pointing device is used that simulates a pencil, the pressure parameter is also translated into the thickness of the line that is drawn. When more pressure is applied, this is translated by the personal computer 110 into a realtime representation of a thick line on the screen and when less pressure is applied, a thinner line is represented. Through this the user can intuitively create thin and thick lines, which resembles the interaction with a real pencil.

Different pointing devices require different feedback, therefore the system comprises pointing device identification capabilities. This is achieved by equipping each pointing device with an RF-tag. Which is read by an RF-tag reader 122. Instead of using RF-tags, each pointing device can be equipped with a transponder that can be read by a transponder reader. The RF-tag reader is connected to the personal computer 110. In case a transponder reader is used, it is also connected to the personal computer 110. Each pointing device has its own unique identification number and the personal computer 110 comprises a database 112 wherein a mapping is maintained from unique identification number to the sound parameters of parameter settings of the corresponding pointing device. It is also possible to use a more simple mapping like a file structure, wherein each unique identification number is a folder which comprises more characteristics of its pointing device like dimensions, color etc.

However, when a user uses his finger to “draw”, the screen 100 will still receive location, speed and pressure parameters and transmit them to the personal computer 110, but the personal computer does not receive a unique identification number. When this is the case, a default sound is selected that simulates the sound of a finger touching paper. Other default sounds can be used too to indicate to a user that a default sound is used.

FIG. 2 illustrates the general parts of an embodiment of the interactive system 230 with a camera array according to the invention in a schematic way. Here, 202 is a camera array comprising two infra-red cameras 212, 214 that can read the position and orientation of the pen shaped pointing device 216. This pen shaped pointing device 216 comprises three Light Emitting Diodes (LEDs) 204, 206, and 208 that are attached such onto the pen shaped pointing device 216 that the coordinates and orientation of the pen can be read by the infra-red cameras of the camera array. Other techniques that result in transmitting location and orientation of the pointing device can be used too. Both the camera-array as the pen shaped pointing device are connected to the personal computer 110. This connection is wired, but wireless is also possible provided that all devices are equipped with corresponding software to receive and transmit the appropriate signals. Furthermore, the pen shaped pointing device comprises a pressure sensor 210. With this embodiment, there's no need for a touch and pressure sensitive panel but a normal display 218 is used. In this case the camera array reads the position and orientation of the pen shaped pointing device and transmits this position and orientation to the personal computer 110. The position is translated into an audible feedback as previously described while the orientation is used to vary the thickness of the drawn line. For example when a crayon is used perpendicular to the display 218, a thin line is visualized on the display in real-time. But when it is used parallel to the display 218, a line is visualized that approximates the width of the crayon and further improves the experience of the user.

When a user wants to add a message or drawing to an existing drawing, the existing drawing can be downloaded into the personal computer 110 in conventional ways: via floppy disk, CD, internet etc. This existing drawing is visualized on the display and the coordinates of the pointing device are translated into coordinates within this drawing enabling a user to add or erase to or from the existing drawing.

The pressure sensor transmits the pressure parameter to the personal computer 110 that translates this parameter into sound as previously described.

Combinations of the described embodiments are also possible in which for example, the panel is a touch sensitive panel and the pointing device comprises a pressure sensor.

More pointing devices like an eraser, stylographic pen, brush, etc. can be added to and removed from the system. For this purpose, the personal computer 110 comprises management software that can be operated via the screen. It is also possible to change the sounds that identify the kind of pointing device used and to change the surface that the screen simulates. The surface can, for example, be changed into rock, glass or a white board. Furthermore, the devices that are operated through the location, speed and pressure parameters can be changed. They can, for example be used to control the surrounding light like its color and intensity.

1. An interactive system (130, 230) comprising:
an input device (100, 202, 216) for inputting data to the interactive system, the inputting being effected by a user operation upon the input device (100, 202, 216) characterized in that the interactive system (130, 230) further comprises:
measuring means (210, 212, 214) conceived to measure a parameter of the user operation; and
converting means (110) conceived to convert the measured parameter into an acoustic signal that depends upon the measured parameter of the user operation.

2. An interactive system (130, 230) according to claim 1, wherein the measured parameter of the user operation is a pressure with which the inputting is being effected and the acoustic signal depends upon this pressure.

3. An interactive system (130, 230) according to claim 1, wherein the measured parameter of the user operation is a location of where the inputting is being effected and the acoustic signal depends upon this location.

4. An interactive system (130, 230) according to claim 1, wherein the measured parameter of the user operation is an orientation with which the inputting is being effected and the acoustic signal depends upon this orientation.

5. An interactive system (130, 230) according to claim 1, wherein the input device is a touch sensitive panel (100).

6. An interactive system (130, 230) according to claim 1, wherein the input device is a pressure sensitive panel (100).

7. An interactive system (130, 230) according to claim 1, wherein the input device is a camera array (202) comprising an infra red camera (212, 214).

8. An interactive system (130, 230) according to claim 1, wherein the acoustic feedback is at least one of pitch, volume and beat.

9. A method of interaction, the method comprising
inputting data to an input device, the inputting being effected by a user operation upon the input device
characterized in that the method further comprises:
measuring a parameter of the user operation; and
converting the measured parameter into an acoustic signal that depends upon the measured parameter of the user operation.
